(19) United States
(12) Patent Application Publication
(10) Pub. No.: US 2024/0426408 A1
(43) Pub. Date: Dec. 26, 2024

(54) BREAKAWAY FLANGE COUPLING DEVICE AND METHOD OF USE

(71) Applicant: Bernard Bryans, Georgetown (CA)

(72) Inventor: Bernard Bryans, Georgetown (CA)

(21) Appl. No.: 18/212,387

(22) Filed: Jun. 21, 2023

(51) Int. Cl. F16L 37/00

(52) U.S. Cl. CPC F16L 37/004; F16L 17/06

(57) ABSTRACT

A breakaway flange coupling device includes a pair of flanges, each have a first face which comprises a mating surface. A first flange is magnetic and a second flange is either paramagnetic or is magnetic and has opposing poles relative to the first flange. The flanges thus are selectively magnetically couplable with the mating surfaces in abutment and with a gasket compressed between them. First and second conduits, which extends from a liquid supply source and a liquid receiving vessel, respectively, are attachable to the flanges by a pair of connectors. The flanges fluidically couple the liquid receiving vessel to the liquid supply source via the first and second conduits. The flanges separate upon movement of either the liquid supply source or the liquid receiving vessel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to breakaway couplers and more particularly pertains to a new breakaway coupler for limiting risk of damage during liquid transfers. Many liquid transfers are performed between liquid supply sources and liquid receiving vessels, wherein one or both of the liquid supply source and the liquid receiving vessel is movable. Operators often forget to detach transfer hoses and cause damage to the liquid supply source and the liquid receiving vessel.

### (2) Description of Related Art Including Information Disclosed Under 37 CFR 1.97 and 1.98

The prior art relates to breakaway couplers but does not teach a breakaway coupler wherein two flanges are attached solely by magnetic attraction, thereby enabling transfers of liquids under gravity flow or low pressure.

### BRIEF SUMMARY OF THE INVENTION

An embodiment of the disclosure meets the needs presented above by generally comprising a pair of flanges. Each flange has a first face, which comprises a mating surface. A first flange of the pair of flanges is magnetic and a second flange of the pair of flanges is either paramagnetic or is magnetic and has opposing poles relative to the first flange. The flanges thus are selectively magnetically couplable with the mating surfaces in abutment. A gasket, which is attached to the first face either the first flange or the second flange, is compressed between the mating surfaces. Each connector of a pair of connectors is attached to and extends from a second face of a respective flange. One of the connectors is configured for selective attachment to a first conduit, which extends from a liquid supply source, while the other connector is configured for selective attachment to a second conduit, which extends from a liquid receiving vessel. The pair of flanges is configured to fluidically couple the liquid receiving vessel to the liquid supply source via the first conduit and the second conduit. The pair of flanges is configured to separate upon movement of either the liquid supply source or the liquid receiving vessel to reduce a risk of damage to any of the first conduit, the second conduit, the liquid supply source, and the liquid receiving vessel.

Another embodiment of the disclosure includes a method of limiting risk of damage during liquid transfers. The method entails provision of the breakaway flange coupling device, according to the disclosure above. Steps of the method are attaching the connectors to the first and second conduits, coupling the flanges, movement of either the liquid supply source or the liquid receiving vessel, and separation of the flanges.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric perspective view of a breakaway flange coupling device according to an embodiment of the disclosure.

FIG. 2 is a front view of an embodiment of the disclosure.

FIG. 3 is a side view of an embodiment of the disclosure.

FIG. 4 is a rear isometric perspective view of an embodiment of the disclosure.

FIG. 5 is a rear view of an embodiment of the disclosure.

FIG. 6 is a cross-sectional view of an embodiment of the disclosure.

FIG. 7 is an in-use view of an embodiment of the disclosure.

FIG. 8 is a flow diagram for a method utilizing an embodiment of the disclosure.

### DETAILED DESCRIPTION OF THE INVENTION

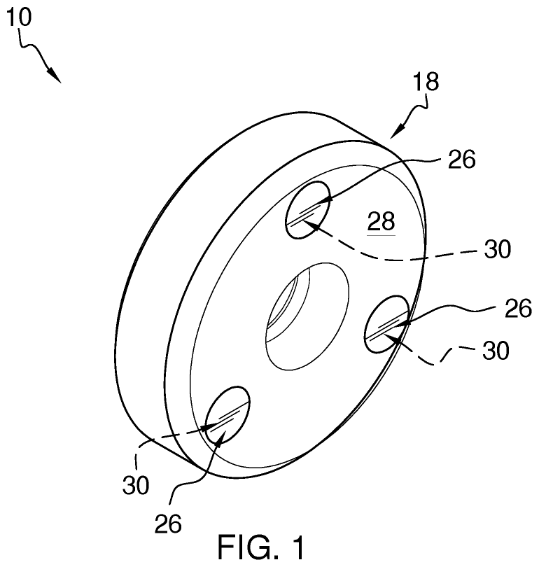

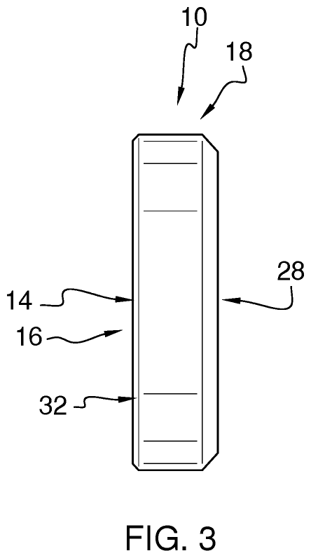

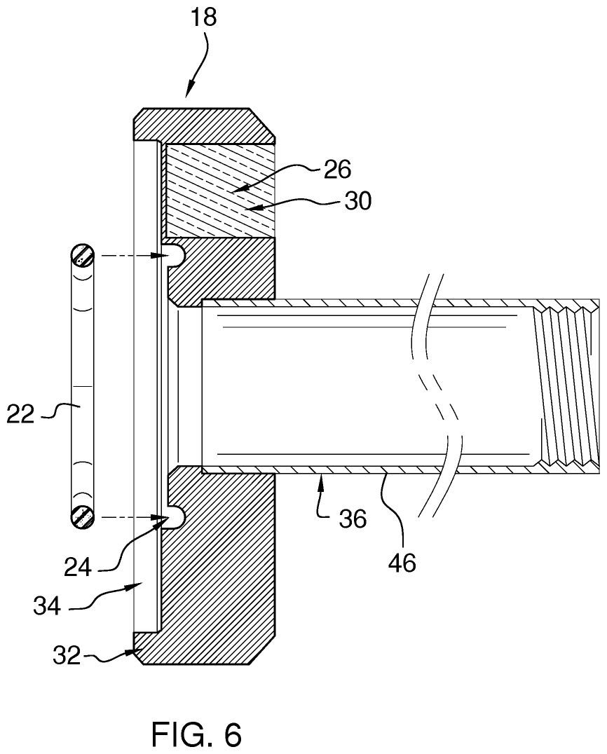

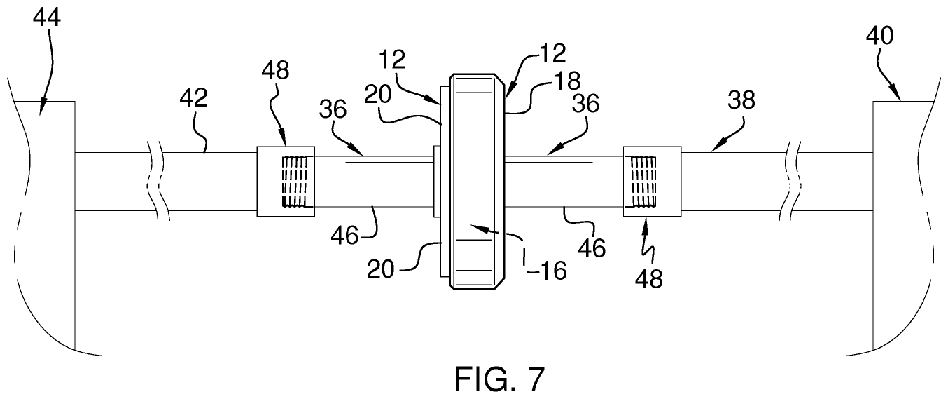

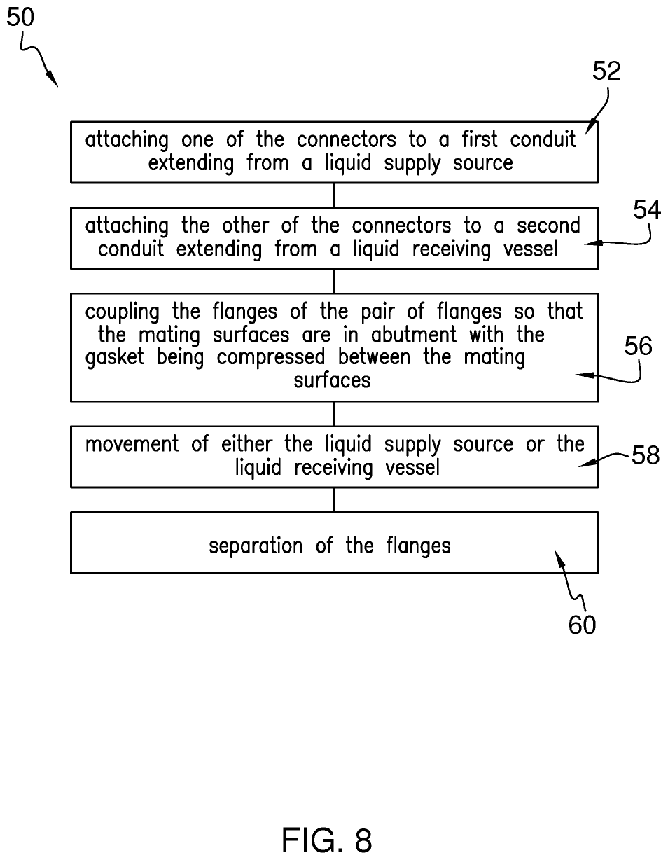

With reference now to the drawings, and in particular to FIGS. 1 through 8 thereof, a new breakaway coupler embodying the principles and concepts of an embodiment of the disclosure and generally designated by the reference numeral 10 will be described.

As best illustrated in FIGS. 1 through 8, the breakaway flange coupling device 10 generally comprises a pair of flanges 12. Each flange 12 has a first face 14, which comprises a mating surface 16. The mating surface 16 may be circular, or alternatively shaped, such as oval, square, or the like. A first flange 18 of the pair of flanges 12 is magnetic and a second flange 20 of the pair of flanges 12 is either paramagnetic or is magnetic and has opposing poles relative to the first flange 18. The flanges 12 thus are selectively magnetically couplable with the mating surfaces 16 in abutment.

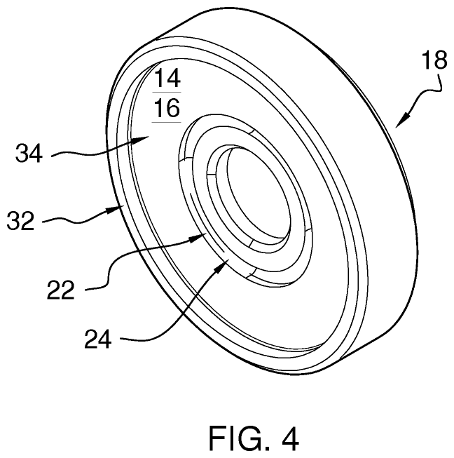

A gasket 22, which is attached to the first face 14 of either the first flange 18 or the second flange 20, is compressed between the mating surfaces 16 upon coupling of the flanges 12. As is shown in FIG. 4, the gasket 22 is positioned in a circular channel 24, which extends into the first face 14 of the first flange 18. The present invention also anticipates both of the flanges 12 being fitted with a gasket 22, with one of the gaskets 22 being circumferentially larger than the other so that the mating surfaces 16 are doubly sealed.

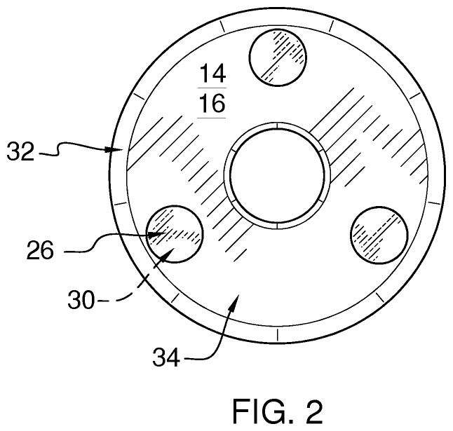

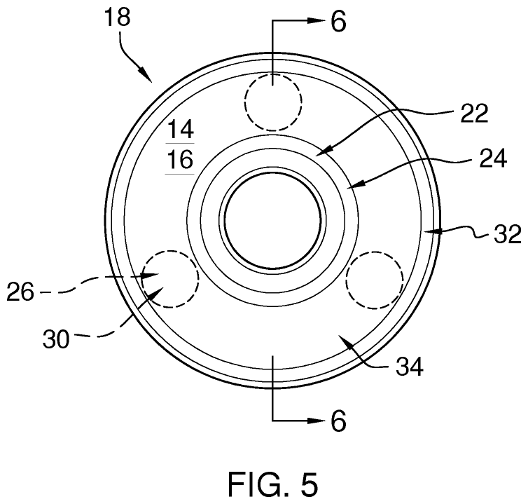

The first flange 18 comprises plastic and the second flange 20 comprises steel. A plurality of magnets 26 is embedded in the first flange 18 so that the first flange 18 is selectively magnetically couplable to the second flange 20. The plurality of magnets 26 comprises at least three magnets 26 to provide for sufficient and dispersed attractive magnetic attraction to the second flange 20. As is shown in FIG. 2, the plurality of magnets 26 comprises three magnets 26, but the present invention anticipates the plurality of magnets 26 comprising four or more magnets 26. The magnets 26 may be recessed into a second face 28 of the first flange 18 so that the mating surface 16 extends over the plurality of magnets 26, as is shown in FIG. 5. The magnets 26 can be attached to the first flange 18 by press fitting of the magnets 26 into appropriately sized recesses 30, but of the magnets 26 also could be adhesively attached to the first flange 18.

A lip 32 is attached to the first flange 18 and extends circumferentially around the mating surface 16 of the first flange 18 to define an inset 34. The second flange 20 is partially insertable into the inset 34 to bring the mating surfaces 16 into abutment. The lip 32 serves to limit lateral movement of the flanges 12 relative to one another.

Each connector 36 of a pair of connectors 36 is attached to and extends from the second face 28 of a respective flange 12. One of the connectors 36 is configured for selective attachment to a first conduit 38, which extends from a liquid supply source 40, while the other connector 36 is configured for selective attachment to a second conduit 42, which extends from a liquid receiving vessel 44. The pair of flanges 12 is configured to fluidically couple the liquid receiving vessel 44 to the liquid supply source 40 via the first conduit 38 and the second conduit 42.

The pair of flanges 12 is configured to separate upon movement of either the liquid supply source 40 or the liquid receiving vessel 44 to reduce a risk of damage to any of the first conduit 38, the second conduit 42, the liquid supply source 40, and the liquid receiving vessel 44. Also anticipated by the present invention is one of the connectors 36 being integral to either the liquid supply source 40 or the liquid receiving vessel 44, which would preclude a requirement of either the first conduit 38 or the second conduit 42, respectively.

The present invention is anticipated to be useful in situations wherein one or both of the liquid supply source 40 and the liquid receiving vessel 44 are movable and the fluid, usually water or a water based solution, is to be transferred from one to the other under gravity flow or low pressure. One example includes the liquid supply source 40 being stationary, such as with a fixed water pipe, and the liquid receiving vessel 44 being movable, such as would be the case for a water truck, an ice surfacing machine, or the like. Another example includes the liquid supply source 40 being movable, such as a water delivery truck, and the liquid receiving vessel 44 being stationary, such as a cistern. The present invention also is anticipated to be useful in other liquid transfer situations that rely on gravity flow, such as, but not limited to, gravity flow transfer of beer, wine, or the like, during processing and/or production.

Each connector 36 may comprise a pipe 46, which is externally threaded distal from the flange 12. The pipe 46 is configured to be threadedly coupled to a female coupler 48 that is attached to the first conduit 38 or to female coupler 48 that is attached to the second conduit 42. The pipe 46 may be threadedly attached to the flange 12, or it may be attached using other attachment means suitable for the materials from which the flanges 12 and pipes 46 are comprised, such as, but not limited to, adhesive attachment, soldering, welding, or the like. The present invention also anticipates each connector 36 comprising other connecting means, such as, but not limited to, quick connects, triclamps fittings, or the like.

In use, the breakaway flange coupling device 10 enables a method of limiting risk of damage during liquid transfers 50. The method 50 entails provision of the breakaway flange coupling device 10. A first step 52 of the method 50 is attaching one of the connectors 36 to a first conduit 38 that extends from a liquid supply source 40. A second step 54 of the method 50 is attaching the other of the connectors 36 to a second conduit 42 that extends from a liquid receiving vessel 44. A third step 56 of the method 50 is coupling the flanges 12 so that the mating surfaces 16 are in abutment with the gasket 22 being compressed between the mating surfaces 16. Liquid then is transferable from the liquid supply source 40 to the liquid receiving vessel 44. A fourth step 58 of the method 50 is movement of either the liquid supply source 40 or the liquid receiving vessel 44. A fifth step 60 of the method 50 is separation of the flanges 12, thereby reducing a risk of damage to any of the first conduit 38, the second conduit 42, the liquid supply source 40, and the liquid receiving vessel 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A breakaway flange coupling device comprising:
a pair of flanges, each flange of the pair of flanges having a first face comprising a mating surface, a first flange of the pair of flanges being magnetic, a second flange of the pair of flanges being either paramagnetic or magnetic and having opposing poles relative to the first flange, such that the flanges of the pair of flanges are selectively magnetically couplable with the mating surfaces in abutment;
a gasket attached to the first face of one of the first flange and the second flange, such that the gasket is compressed between the mating surfaces; and
a pair of connectors, each connector of the pair of connectors being attached to and extending from a second face of a respective flange of the pair of flanges, one of the connectors of the pair of connectors being configured for selective attachment to a first conduit extending from a liquid supply source, the other of the connectors of the pair of connectors being configured for selective attachment to a second conduit extending from a liquid receiving vessel, wherein the pair of flanges is configured to fluidically couple the liquid receiving vessel to the liquid supply source via the first conduit and the second conduit, and wherein the pair of flanges is configured to separate upon movement of either the liquid supply source or the liquid receiving vessel to reduce a risk of damage to any of the first conduit, the second conduit, the liquid supply source, and the liquid receiving vessel; and
a lip attached to the first flange and extending circumferentially around the mating surface of the first flange defining an inset, the second flange having a dimension greater than a depth of the insert wherein the second flange is partially insertable into the inset to bring the mating surfaces into abutment.

2. The breakaway flange coupling device of claim 1, wherein the mating surfaces are circular.

3. The breakaway flange coupling device of claim 1, further including:
the first flange comprising plastic;
the second flange comprising steel; and
a plurality of magnets embedded in the first flange, such that the first flange is selectively magnetically couplable to the second flange.

4. The breakaway flange coupling device of claim 3, wherein the plurality of magnets comprises at least three magnets.

5. The breakaway flange coupling device of claim 3, wherein the magnets of the plurality of magnets are recessed into the second face of the first flange, such that the mating surface extends over the plurality of magnets.

6. (canceled)

7. The breakaway flange coupling device of claim 1, wherein the gasket is positioned in a circular channel extending into the first face of the first flange.

8. The breakaway flange coupling device of claim 1, wherein each connector of the pair of connectors comprises a pipe, the pipe being externally threaded distal from the flange, wherein the pipe is configured for threaded coupling to a female coupler attached to the first conduit or to a female coupler attached to the second conduit.

9. A breakaway flange connector comprising:
a pair of flanges, each flange of the pair of flanges having a first face comprising a mating surface, a first flange of the pair of flanges being magnetic, a second flange of the pair of flanges being either paramagnetic or magnetic and having opposing poles relative to the first flange, such that the flanges of the pair of flanges are selectively magnetically couplable with the mating surfaces in abutment, the mating surfaces being circular, the first flange comprising plastic, the second flange comprising steel;
a plurality of magnets embedded in the first flange, such that the first flange is selectively magnetically couplable to the second flange, the plurality of magnets comprising at least three magnets, the magnets of the plurality of magnets being recessed into a second face of the first flange, such that the mating surface extends over the plurality of magnets;
a lip attached to the first flange and extending circumferentially around the mating surface of the first flange defining an inset, the second flange having a dimension greater than a depth of the insert wherein the second flange is partially insertable into the inset to bring the mating surfaces into abutment;
a gasket attached to the first face either the first flange or the second flange, such that the gasket is compressed between the mating surfaces, the gasket being positioned in a circular channel extending into the first face of the first flange; and
a pair of connectors, each connector of the pair of connectors being attached to and extending from the second face of a respective flange of the pair of flanges, one of the connectors of the pair of connectors being configured for selective attachment to a first conduit extending from a liquid supply source, the other of the connectors of the pair of connectors being configured for selective attachment to a second conduit extending from a liquid receiving vessel, wherein the pair of flanges is configured to fluidically couple the liquid receiving vessel to the liquid supply source via the first conduit and the second conduit, and wherein the pair of flanges is configured to separate upon movement of either the liquid supply source or the liquid receiving vessel to reduce a risk of damage to any of the first conduit, the second conduit, the liquid supply source, and the liquid receiving vessel, each connector of the pair of connectors comprising a pipe, the pipe being externally threaded distal from the flange, wherein the pipe is configured for threaded coupling to a female coupler attached to the first conduit or to a female coupler attached to the second conduit.

10. A method of limiting risk of damage during liquid transfers, the method comprising providing a breakaway flange coupling device of claim 1, and:
attaching one of the connectors of the pair of connectors to a first conduit extending from a liquid supply source;
attaching the other of the connectors of the pair of connectors to a second conduit extending from a liquid receiving vessel;
coupling the flanges of the pair of flanges so that the mating surfaces are in abutment with the gasket being compressed between the mating surfaces, such that liquid is transferable from the liquid supply source to the liquid receiving vessel;
movement of either the liquid supply source or the liquid receiving vessel; and
separation of the flanges of the pair of flanges, thereby reducing a risk of damage to any of the first conduit, the second conduit, the liquid supply source, and the liquid receiving vessel; and
a lip attached to the first flange and extending circumferentially around the mating surface of the first flange defining an inset, the second flange having a dimension greater than a depth of the insert wherein the second flange is partially insertable into the inset to bring the mating surfaces into abutment.

11. The method of claim 10, wherein the mating surfaces are circular.

12. The method of claim 10, further including:
the first flange comprising plastic;
the second flange comprising steel; and
a plurality of magnets embedded in the first flange, such that the first flange is selectively magnetically couplable to the second flange.

13. The method of claim 12, wherein the plurality of magnets comprises at least three magnets.

14. The method of claim 12, wherein the magnets of the plurality of magnets are recessed into the second face of the first flange, such that the mating surface extends over the plurality of magnets.

15. (canceled)

16. The method of claim 10, wherein the gasket is positioned in a circular channel extending into the first face of the first flange.

17. The method of claim 10, wherein each connector of the pair of connectors comprises a pipe, the pipe being externally threaded distal from the flange, wherein the pipe is configured for threaded coupling to a female coupler attached to the first conduit or to a female coupler attached to the second conduit.
